(19) United States
(12) Patent Application Publication
(10) Pub. No.: US 2014/0058832 A1
(43) Pub. Date: Feb. 27, 2014

(54) AD PARTNER REVENUE SHARE AND FINANCIAL TERMS LIBRARY

(71) Applicants: Juelu Zhang, Shanghai (CN); Sean Harvey, Astoria, NY (US); Heng Lei, Shanghai (CN); Ling Ren, Shanghai (CN); Brian Stephen O'Clair, New York, NY (US); Qifeng Tan, Shanghai (CN)

(72) Inventors: Juelu Zhang, Shanghai (CN); Sean Harvey, Astoria, NY (US); Heng Lei, Shanghai (CN); Ling Ren, Shanghai (CN); Brian Stephen O'Clair, New York, NY (US); Qifeng Tan, Shanghai (CN)

(21) Appl. No.: 13/638,911

(22) PCT Filed: Aug. 23, 2012
(86) PCT No.: PCT/CN2012/080512

§ 371 Date: Apr. 24, 2013

(51) Int. Cl. G06Q 30/02

(52) U.S. Cl. CPC G06Q 30/0247
USPC 705/14.46

(57) ABSTRACT

Systems and methods for creating and managing financial term objects are disclosed herein for generating, based on a publisher's input, a plurality financial term objects. A financial term object includes a set of rules that govern how revenue is divided between a partner and a publisher when a supplemental content object is displayed to a user in response to the user accessing an online property of the partner. After generating the financial term object, the publisher may use the system to system store the financial term object in a database. After storing the financial term object, the system allows the publisher to associate the plurality of financial term objects with a plurality of partners. After associating the financial term objects, the system may then calculate at least one revenue share owed to the partner based on a financial term object.

### BACKGROUND OF THE DISCLOSURE

As the Internet continues to grow it has become increasingly common for multiple entities to collaborate on the generation of a given web page. For example, the page itself may be a composite of the core website publisher and one or more external content providers who distribute their content for consumption. The content provider in turn may be responsible for managing payments to multiple content rights holders, and may be distributing the same content on multiple publisher partner websites. Sometimes network intermediaries are involved whose role is to manage the distribution of this content across multiple partner publisher websites. The revenue generated from these partnerships is shared according to a set of financial terms agreed upon by the parties involved.

### SUMMARY OF THE DISCLOSURE

Aspects and implementations of the present disclosure are directed to systems and methods for creating and managing financial term objects. According to one aspect, a system for creating and managing financial term objects includes at least one processing circuit configured to generate, based on a publisher's input, a financial term object. The financial term object includes a set of rules that govern how revenue is divided between a partner and a publisher when a supplemental content object is displayed to a user in response to the user accessing an online property of the partner. After generating the financial term object, the system stores the financial term object in a database, associates the financial term object with a publisher and a first partner, associates the financial term object with the publisher and a second partner, associate a second financial term object with the publisher and a third partner, and then calculates at least one revenue share owed to each of the first, second, and third partners based on the financial term object and the second financial term object.

In some implementations, in response to receiving an update to the financial term object, the processing circuit is configured to apply the updated financial term object to all future revenue allocations between the publisher and the first and second partners. In some implementations, the processing circuit is configured to retroactively apply the updated financial term object to previous revenue allocations. In some embodiments, the set of rules comprises a first revenue share being associated with a first and second geographic location, the previous number of views of the supplemental content, a first and second content size, and/or a first and second content type. In some embodiment the supplemental content object may be an online advertisement. In some embodiments, the system may be configured to output a user interface for use in generating the financial term object.

According to another aspect, a method for creating and managing financial term objects includes at least one processing circuit generating, based on a publisher's input, a financial term object. The financial term object includes a set of rules that govern how revenue is divided between a partner and a publisher when a supplemental content object is displayed to a user in response to the user accessing an online property of the partner. The method further include, by the at least one processing circuit, storing the financial term object in a database, associating the financial term object with a publisher and a first partner, associating the financial term object with the publisher and a second partner, associating a second financial term object with the publisher and a third partner, calculating at least one revenue share owed to each of the first, second, and third partners based on the financial term object and the second financial term object.

In some implementations, the method includes responding to receiving an update to the financial term object by applying the updated financial term object to all future revenue allocations between the publisher and the first and second partners. In some implementations, the method includes retroactively applying the updated financial term object to previous revenue allocations. In some implementations, the method further includes outputting a user interface for use in generating the financial term object. In some implementations, the rules included in the financial terms objects include a revenue share associated with first and second geographic locations, the previous number of views of the supplemental content, first and second content sizes, and/or first and second content types.

Another aspect of the disclosure relates to a computer readable medium having instructions that are executed by at least one processor. The instructions may include generating, based on a publisher's input, a financial term object. The financial term object includes a set of rules that govern how revenue is divided between a partner and a publisher when a supplemental content object is displayed to a user in response to the user accessing an online property of the partner. The instructions further include storing the financial term object in a database, associating the financial term object with a publisher and a first partner, associating the financial term object with the publisher and a second partner, associating a second financial term object with the publisher and a third partner, calculating at least one revenue share owed to each of the first, second, and third partners based on the financial term object and the second financial term objects.

In some implementations, the set of rules comprise a first revenue share associated a first geographic location and a second revenue share associated with a second geographic location. In other implementations the set of rules comprises a first revenue share associated with a first content type and a second revenue share associated with a second content type.

### BRIEF DESCRIPTION OF THE DRAWINGS

The skilled artisan will understand that the figures, described herein, are for illustration purposes only. It is to be understood that in some instances various aspects of the described implementations may be shown exaggerated or enlarged to facilitate an understanding of the described implementations. In the drawings, like reference characters generally refer to like features, functionally similar and/or structurally similar elements throughout the various figures. The drawings are not necessarily to scale, emphasis instead being placed upon illustrating the principles of the teachings. The drawings are not intended to limit the scope of the present teachings in any way. The system and method may be better understood from the following illustrative description with reference to the following drawings in which:

FIG. 1 is a block diagram of an example environment in which financial term objects can be employed to govern publisher-partner revenue sharing, according to an illustrative embodiment of the invention;

FIG. 2 is a flow chart illustrating a method for calculating revenue shares using financial term objects, according to an illustrative embodiment;

FIG. 3 is a flow chart illustrating a method for calculating revenue shares for multiple parties using financial term objects, according to an illustrative embodiment;

FIG. 4 is a flow chart illustrating a method for creating and updating financial term objects, according to an illustrative embodiment;

FIG. 5 is a flow chart illustrating a method for applying financial term override objects, according to one illustrative embodiment;

FIG. 6 is a block diagram illustrating a general architecture for a computer system that may be employed to implement various elements of the systems and methods described and illustrated herein, according to an illustrative embodiment.

### DETAILED DESCRIPTION OF THE PREFERRED EMBODIMENTS

The various concepts introduced above and discussed in greater detail below may be implemented in any of numerous ways, as the described concepts are not limited to any particular manner of implementation. Examples of specific implementations and applications are provided primarily for illustrative purposes.

The present system and methods described herein generally relate to a system for enhanced creation and management of data objects that govern how revenue is shared among a publisher and a partner when the partner presents content supplied by the publisher via the partner's online property 124. When a partner presents content provided by a publisher through the partner's online property 124 the partner and publisher typically split any revenue generated as a result of the presentation according to pre-arranged financial terms. A computer system generates, manages, and applies a library of reusable financial term objects that facilitates many such publisher-partner relationships and accounts for revenue derived there through. In some embodiments, this system may be included in a content management system.

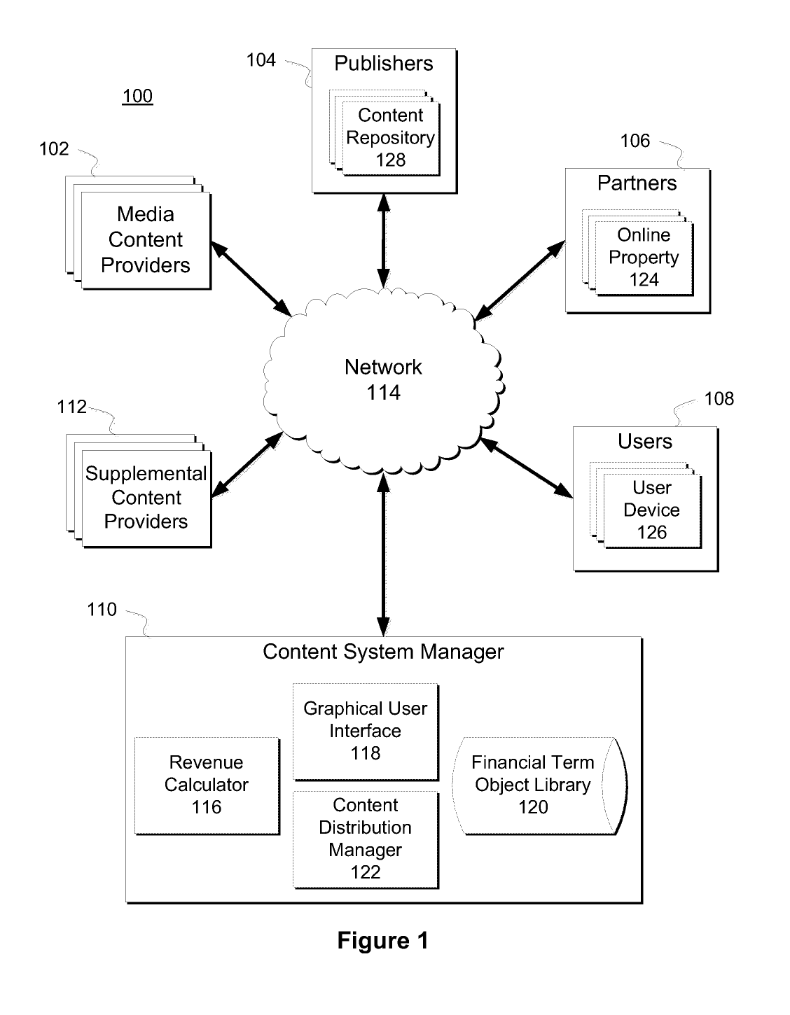

FIG. 1 illustrates an example environment 100 in which revenue is generated by displaying publisher-generated content on partner-owned online properties 124, in accordance with a described implementation. The environment 100 can include a network 114, such as a local area network (LAN), a wide area network (WAN), wireless area network, intranets, and other communication networks such as mobile telephone networks, the Internet, or a combination thereof. The network 114 connects media content providers 102, publishers 104, partners 106, user's 108, a content system manager 110, and supplemental content providers 112. By accessing the network 114, a user 108 can retrieve content provided on a partner-owned online property 124 via a user 108 device 126. The environment 100 can include a plurality of each of the content providers 102, publishers 104, partners 106, users 108, content system managers 110, and supplemental content providers 112.

In the illustrated system 100, partner-owned online properties 124 can be viewed by users 108. A user 108 may access a partner-owned online property 124 with a user device 126 that is under the control of the user 108 and is capable of requesting and receiving content over the network 114. Example user devices 126 can include a laptop, a personal computer, tablet, electronic pad, personal digital assistant, mobile communication device, smart phone, television, kiosk, and other devices that can send and receive data over the network 114. The user device 126 typically includes a user application, such as a web browser, to facilitate the sending and receiving of data over the network 114.

The system 100, as illustrated, includes at least one partner-owned an online property 124. This property can include, but is not limited to websites, social media sites, business outlets or any other network accessible property. The partner 106 generates a plurality of content, which a user 108 can access. These properties may include a plurality of content types such as blogs, media, articles, documents, or any other network accessible content. In addition to this content, the partner-owned properties 106 include space for the display of supplemental content supplied by a publisher 104. This supplemental content is not limited to, but can include, supplemental information, links to related content, and advertisements. For example, in relation to an on-line property displaying news articles, supplemental content may include additional headlines, sports scores, financial market data, or advertisements. In some implementations, the supplemental content is delivered to the partner via an content system manager 110.

When a partner 106 intends to display content from a publisher 104, the partner may allocate regions of an online property 124 to display the content from the publisher 104. In this embodiment, the partner may fill reserved space on an online property by pulling content from a publishers content repository 128. The partner 106 may insert code provided to the publisher 104 by the content system manager 110 into an online property 124 to automatically pull content from the publisher's content repository 128 upon its execution by a user device 126 operated by a user 108.

As illustrated in the system 100, there may be a plurality of supplemental content providers 112. The supplemental content providers 112 may generate a plurality of supplemental content objects. After generating content, the supplemental content provider may then pay the publisher 104 to publish the supplemental content on a partner-owned online property 124. After supplying the partner 106 with content, revenue (in the form of fees from the supplemental content provider) is generated for the publisher 104 and partner 106 when users 108 view or access the supplemental content. In some embodiments the supplemental content is characterized by supplemental content parameters. These parameters may be used to classify the supplemental content for later deployment. In other embodiments, the parameters may be used to target specific users 108. In some embodiments these parameters may include an inventory unit identifier, a content source identifier, a line item, a priority level, a content type, and geographical information. With these supplemental content parameters, partners 106, publishers 104, and supplemental content providers 112 may define a set of financial terms that govern the generation of revenue when a user 108 views the supplemental content.

The system 100, as illustrated, also includes at least one media content provider 102. Media content providers 102 generate multimedia content. For example, media content may include videos, games, audio, dynamic web pages or other network accessible media content. In some embodiments the media content provider differs from a partner in that media content providers may not directly display content to a user 108. In such an embodiment, the media content provider provides its content to a partner via a publisher. In other embodiments, the media content provider 102 can supply content to a partner directly. In some embodiments, the content generated by a media content provider is associated with a plurality of rights holders. For example, a movie may have numerous rights holders such as a movie studio, director, actors, and other parties involved in the generation of the media content.

According to this illustration, the system 100 also includes at least one publisher 104. A publisher 104 may provide content to a partner 106 to be viewed be a user 108. A supplemental content provider may request a publisher 104 to distribute the supplemental content to a plurality of partners 106 for display on the partner-owned online properties 124. In exchange for distributing the supplemental content, the supplemental content provider provides the publisher with revenue. The revenue generation may be based on a plurality of payment models that can include a flat fee, or be based on actions taken by the user 108, such as cost-per-click, cost-per-thousand impressions, cost-per-action or any cost-per-basis fee. In some embodiments, a publisher 104 creates a distribution network containing a plurality of partners 106. In one example, a publisher may agree to provide the partner 106 with a share of the revenue which the supplemental content provider 112 pays the publisher 104 when a user 108 views, accesses, or interacts with the online property 124 containing the supplemental content. In one embodiment, the publisher may enter into an agreement with the supplemental content provider, and after doing so the publisher may collect the supplemental content from the supplemental content provided and store it in a content repository.

In addition to supplying the partner directly with supplemental content, the publisher may also supply the partner 106 with content generated by a media content provider. In some embodiments, the publisher may embed supplemental content into the media content before placing the media content into the content repository 128. This could include inserting a video or audio commercial advertisement into a plurality of media files supplied by the media content provider 102. In other embodiments, the media content can be provided directly to the partner 106. In such an embodiment, the online property 124 is configured in such a way that when a user device 126 accesses the online property 124, requests for supplemental content are made to the content repository 128 as the user 108 views the media content. As the supplemental content is provided to the online property 124, it is intermittently displayed to the user as the user views the media content.

The illustration of FIG. 1, also includes at least one content system manager 110. According to the illustration, the content system manager 110 includes a revenue calculator 116, a graphical user interface 118, a financial term object library 120, and a content distribution manager 122. The content system manager 110 is used to facilitate the technical and financial relationship between a publisher 104 and partner 106. When content from a partner-owned online property 124 is request by a user 108, the content system manger 110 handles the distribution of content from the publisher 104 to the partner 106.

The distribution and management of content is handled by the content system manager's content distribution manager 122. The content distribution manager 122 supplies the publisher with code, which the publisher may then in turn provide to partners 106. Once the code is placed in the online property 124 of a partner 106, the code, when executed by a processor, dynamically retrieves content from the content repository 128 to fill the allocated space on the online property 124. Based on requirements set forth by the supplemental content provider 112, the publishers 104 and partners 106 may actively select specific content from the content repository to display to users 108. In some embodiments, the content distribution manager 122 may refine the selection of content the partner has from the content repository 128 by employing the above mentioned supplemental content parameters. For example, if a supplemental content provider 112 wishes their content to only be displayed to users 108 in New York City, N.Y., the content distribution manager may restrict the partner from retrieving content containing the New York City, N.Y. supplemental content parameter, unless the user 108 is currently in New York City, N.Y. In other embodiments, the content distribution manager, may process requests from the partner for specific types of content. For example, the partner may wish to not display content with animations. In this embodiment, the content distribution manager 122 would handle the request, thus allowing the partner to only retrieve non-animated content from the content repository 128. In other embodiments, the content distribution manager 122 may monitor if a user 108 interacts with content from the content repository once embedded in an online property 124.

In some embodiments, the content system manager 110 may also include a graphical user interface 118. The user interface 118, can provide a graphical environment to facilitate the interaction between publisher and partners. The user interface 118 may be accessed through the content system manger's online property 124. Access to the user interface 118 may be secured using passwords, encryption, security keys or other security measures. In some implementations, the user interface 118 may allow the publisher and partner to establish revenue sharing agreements. Once established, the publisher may then use the user interface 118 to create financial term objects. These objects encompass the rules set forth by the revenue sharing agreement. In some implementations, the publisher may create the financial term objects by using a plurality of menus, options and other interactive elements in the user interface 118. Once created, the publisher may save the financial term object to the financial term object library 120. Once stored, the publisher may associate the financial term object with a plurality of content objects, content distribution campaigns, content types, and/or partners. In some embodiments, if the publisher updates the financial term object stored in the financial term library, the modified financial term object may be automatically reassociated to all content to which it was previously associated, and notice of the change may be forwarded to any affected partners associated with the affected content.

In some embodiments, the content system manager 110 may also include a revenue calculator 116. As set forth above, the supplemental content provider supplies the publisher with revenue for distributing content to online properties 106. The content distribution manager 122 may monitor the distribution of the supplemental content to online properties. The distribution manager 122 may also be capable of monitoring user 108 interaction with the supplemental content if dictated by the payment model defined in the revenue share agreement. To calculate the revenue due to each party, the revenue calculator 116 may gather information from the content distribution manger 122. The revenue calculator 116 may then access the financial term object library to determine the current financial agreements between the parties. It may then retrieve the financial term objects from the financial term library and associate them to content distribution events. For example, a supplemental content provider may enter into an agreement with a publisher to pay the publisher $10 per thousand views of supplemental content. The publisher may then enter into an agreement to provide 50% of the generated revenue to the partner resulting from the content being viewed on a partner-owned online property 124. For the purpose of this example, the supplemental content is viewed 1,000 times on the partner's online property 124. To determine the revenue due to each party, the revenue calculator 116, requests the number of views from the content distribution manager 122. It then accesses the financial term object library for the financial term object governing the partnership between the partner and publisher. The revenue calculator 116 may then calculate the publisher is due $5 (1000 views×$10/1000s view×50%) and the partner is also due $5 (1000 views×$10/1000s×50%).

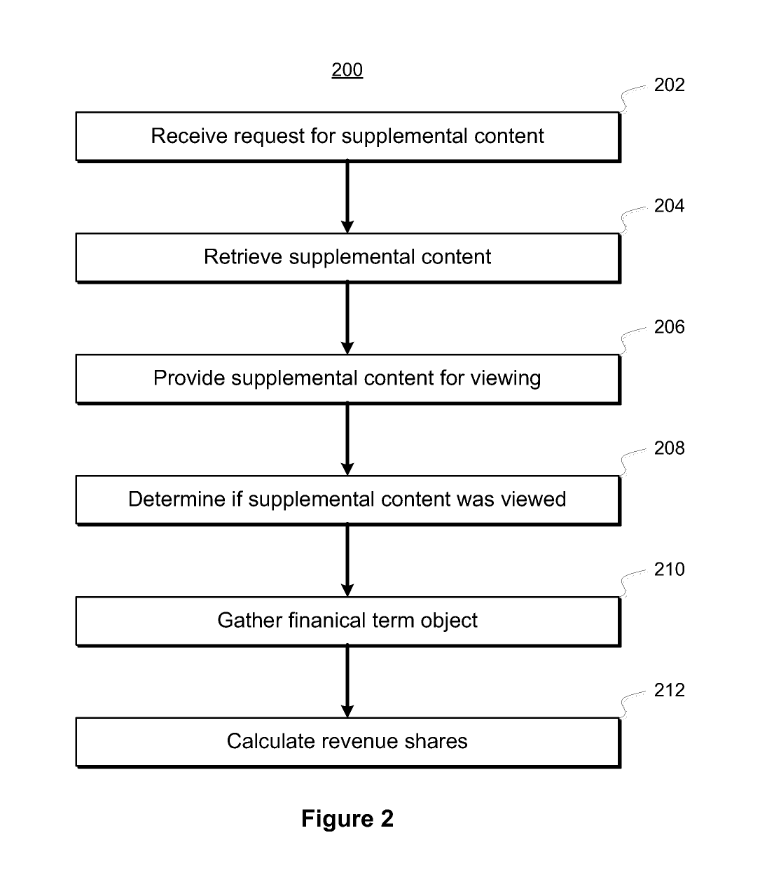

FIG. 2 is a flow chart of a method for calculating revenue shares 200. Generally, the content system manager receives a request for supplemental content (step 202). The content system manager retrieves supplemental content (step 204). The content system manager then provides the supplemental content to the requester of the supplemental content (step 206). The content system manager determines if the supplemental content was viewed (step 208). The content system manager then retrieves a financial term object form the financial term object library (step 210) and then calculates the revenue shares (step 212) based on the retrieved financial term object.

As set forth above, the method for calculating revenue shares 200 begins with the content system manager 110 receiving a request for supplemental content (step 202). For example, the content system manager may receive a request for supplemental content in response to a user 108 initiating a request to view a partner-owned online property 124. In some implementations, the request for supplemental content is generated by computer executable code inserted into the online property 124 which is automatically executed by a processor operating on a user device 126 upon the user device accessing the online property 124. The computer executable code causes the user device 126 processor to automatically request content from the content distribution manager 122. In such an example, every time a request to view the online property 124 is made, a request is automatically placed with the content management system 110 for supplemental content.

The method for calculating revenue shares 200 continues with the content system manager retrieving the supplemental content (step 204). In some implementations the content distribution manager 122 may first determine if any content supplemental parameters are included with the request for supplemental content. For example, when executed by the user device 126, the code the partner 106 placed in the online property requests a specific type of supplemental content. In some implementations, the content distribution manager 122 may then retrieve the supplemental content from the publisher's content repository 128 via the network 114.

Next, the content system manager provides the supplemental content to the online property 124 (step 206). In some implementations, the online property 124 may be a webpage hosted on a web server. After receiving the online property 124 via the network 114 the user device 126 executes the code contained within the online property 124. During this process the user device 126 receives the supplemental content from the content system manager 110. After receiving the supplemental content via the network 114, the user device 126 compiles the webpage for view by the user 108 on the user device 126.

The method for calculating revenue shares 200 continues with the content system manager determining if the supplemental content was viewed (step 208). In some embodiments, based on the financial agreements between the publisher, partner and supplemental content provider, it may be important to determine if a user 108 actually viewed and/or interacted with the supplemental content. For example, the code the distribution manager 122 provided the partner 106 notifies the content system manager 110 if a user 108 clicks on the supplemental content. The content system manager 110 may be notified of this activity over the network 114.

Then, the content system manager retrieves a financial term object from the financial term object library. In some implementations, after the content distribution manager 122 has delivered the content to the online property 124, the content system manager may need to determine if revenue is due to any party. To do so, the revenue calculator 116 retrieves the financial term object for the appropriate publisher-partner relationship or inventory unit identifier, content source identifier, line item, priority level, content type, or geographical information from the financial term object library.

The method for calculating revenue shares 200 continues with the content system manager calculating the revenue shares due to each party (212). In some implementations, after the revenue calculator 116 has retrieved the appropriate financial term object from the financial term object library (step 210), it may request, from the content distribution manager 122, information about interaction the user 108 had with the supplemental content. After receiving the required data, the revenue calculator 116 may then calculate the revenue due to each party based on the terms defined in the financial term object and the interaction of the user 108 with the supplemental content. In some implementations, the revenue calculator 116 may calculate the revenue shares on one of a plurality of time scales. For example, revenue shares may be calculated per transaction, daily, weekly, monthly, or on any other time scale appropriate for the defined financial terms. Alternatively, the revenue share calculation process may be event driven. For example, revenue may be calculated for a supplemental content object every thousand impressions or interactions with the supplemental content. In some embodiments, the revenue calculator 116 may report the revenue shares to a plurality of parties via the graphical user interface 118.

In another example, over the course of a reporting period, the content system manager 110 compiles aggregate counts of content views and interactions for each content item being displayed. The aggregation can be maintained at the level of granularity needed to adequately associate all financial term objects applicable to the content. For example, if the financial term objects applicable to a set of content items includes different revenue share splits depending on whether each content item in the set of content items was viewed in one of three geographic regions, the content system manager 110 maintains three counts associated with the set of content items, one for each geography. If the applicable financial terms object further distinguishes between a user merely viewing a content item and a user interacting with (e.g., clicking on or hovering over) a content item, the content system manager 110 may store six counts for the set of content items, i.e., one count for each geography/interaction type pairing. In this fashion, the revenue calculator 116 does not have to individually associate a revenue share rule to each and every instance of a content item being presented to a user. It only need associate it to each relevant count maintained by the system.

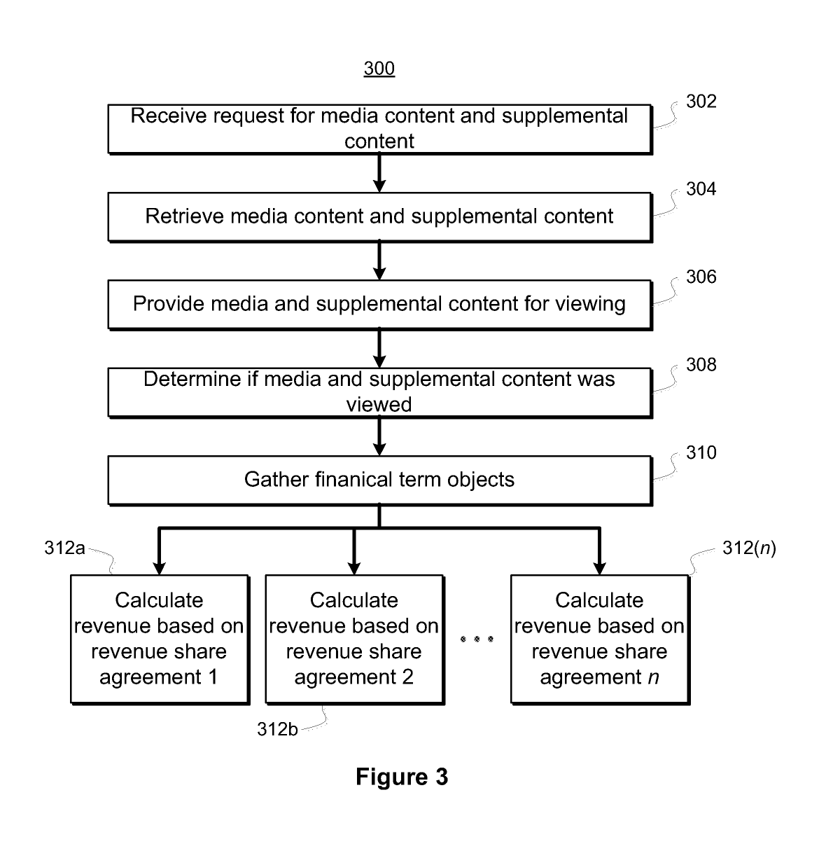

FIG. 3 is a flow chart of a method for determining the revenue shares when multiple partners and financial term objects are involved 300. Generally, a request is made to a content system manager for media content and supplemental content (step 302). The content system manager retrieves the media content and supplemental content (step 304). The content system manager provides the media content and supplemental content to a partner (step 306). The content system manager determines if a user 108 viewed the media content and supplemental content (step 308). The content system manager gathers the financial term objects associated with the distribution of the content to the partner (step 310). The content system manager calculates the revenue share for each of the partners involved in the distribution of the content (step 312).

As set forth above, the method for determining the revenue shares when multiple partners and financial term objects are involved 300 begins when a request is made to the content system manager for supplemental content and media content (step 302). In some implementations, this may occur when a user 108 requests to view an online property 124. The online property 124 may then request media content and supplemental content from a publisher 104 via the content distribution manager 122. For example, a user 108 may wish to view a movie on a online property 124 such as a webpage. In other implementations, the online property 124 may request the supplemental content from a publisher 104 and separately request media content from a media content provider 102. The online property 124 may then intermittently place the supplemental content into the media content as it is viewed by a user 108.

At step 304, the content system manager retrieves the media content and supplemental content. In some implementations the content distribution manager 122 may first determine if any content parameters are included with the request for media content and supplemental content. For example, the online property 124 may request a specific type of media content and supplemental content, such as a video of a specific size. In some implementations, the content distribution manager 122 may then retrieve the media content and supplemental content from the publisher's content repository 128. In other implementations, the content distribution manager 122 may then retrieve the supplemental content, while the online property 124 independently retrieves the media content.

The method 300 continues with the content system manager providing the media content and supplemental content to the online property 124 (step 306). In some implementations the content system manager may provide the supplemental content and a media partner provides the media content. In some implementations, the online property 124 may be a webpage hosted on a web server. The online property 124 may then compile the webpage, incorporating the media content and supplemental content with the online property 124 content displaying the online property 124 to the user 108.

Next, the content system manager gathers the financial term objects for each of the parties involved in distribution of the supplemental content associated with the media content (step 310). In some implementations, the revenue calculator 116 accesses the financial term object library to gather the plurality of required financial term objects. In some implementations, multiple parties and multiple financial term objects may be involved in the calculation on revenue shares when the multiple parties are rights holders to the media content. For example, in the creation of media content, such as a movie, a plurality of rights holders may be involved, including a director, actors, and any number of other parties. In such an example, the revenue calculator 116 may retrieve the financial term objects for each of these rights holders in addition to the financial term object governing the partner-publisher relationship in order to calculate the all the required revenue shares.

Finally, the content system manager calculates the revenue shares based on each financial term object collected in step 310 (step 312). In some implementations, after the revenue calculator 116 has retrieved the appropriate financial term objects from the financial term object library, it may request information about the interaction the user 108 had with the media content containing supplemental content. The revenue calculator 116 may then calculate the revenue due to each party based on the terms defined in the financial term objects and the interaction of the user 108 and the supplemental content contained in the media content. In some implementations, the revenue calculator 116 may calculate the revenue shares on a plurality of time scales. For example, revenue shares may be calculated per transaction, daily, weekly, monthly, or on any other time scale appropriate for the defined financial terms. In some embodiments, the revenue calculator 116 may report the revenue shares to a plurality of parties via the graphical user interface 118.

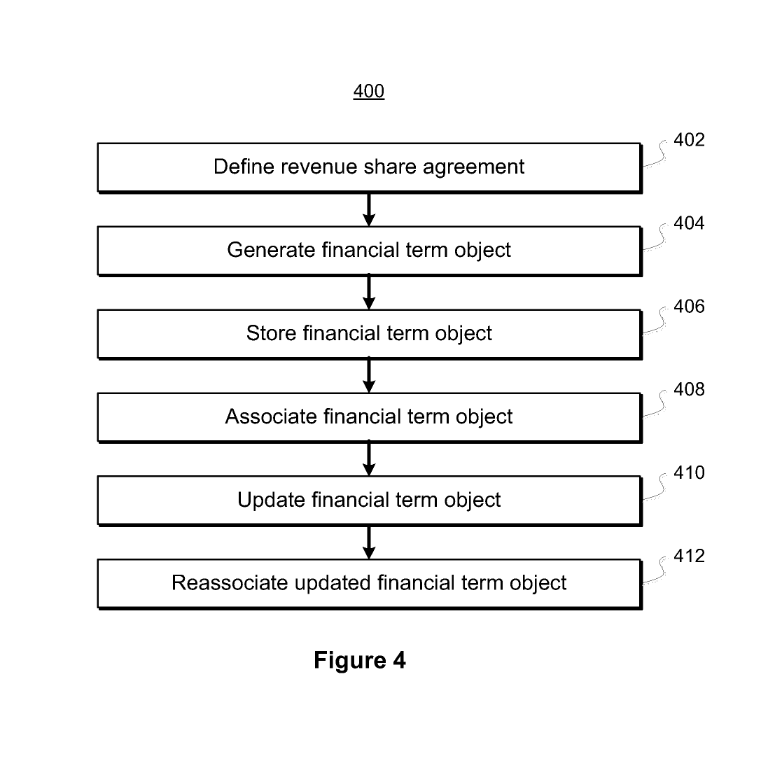

FIG. 4 is a flow chart of a method for generating, updating and reassociating financial term objects 400. Generally, a publisher defines a revenue share agreement (step 402). The publisher then generates a financial term object (step 403). Next, the publisher stores the financial term object (step 406). The publisher then associates the financial term object (step 408). Next, the publisher updates the financial term object (step 410). Finally the financial term object is reassociated to all associated parties (step 412).

As set forth above, the method for generating, updating and reassociating financial term objects 400 begins with a publisher defining a revenue share agreement (step 402). In some implementations, the publisher and partner may interact via a content system manager 110 to agree upon a financial share agreement establishing how revenue is shared from the display of content on the partner-owned online property 124.

Then, a publisher generates a financial term object (step 404). In some implementations, the publisher may use the content system manager's graphical user interface 118 to create a financial term object. For example, the publisher 104 may log into the content system manager's online property 124 to gain access to the graphical user 108 interface. The graphical user interface 118 may contain a section specifically configured for the generation of financial term objects. Here, using a plurality of interactive features, the publisher may create a financial term object corresponding to revenue share agreements. The revenue share agreement between the publisher 104 and the partner 106 contains specific revenue parameters that dictate how revenue is to be shared. These revenue parameters can dictate that revenue is shared at a variable rate, a fixed rate, with no regard to specifics about the supplemental content, or based on the specific supplemental content item. By generating a financial term object, the publisher 104, creates a set of instructions the content system manager 110 follows to calculate revenue shares. For example, a publisher 104 may create a financial term object that dictates that 20% of the revenue is disbursed to the partner 106 when a user 108 located in North America views supplemental content during business hours; 30% when a user 108 located in Montana views supplemental content; or 25% is distributed to the partner 106 when a user 108 located in any geographic location views supplemental content contained within media content. In other implementations, the set of rules defines which of several revenue shares may apply based on the aggregate number of impressions of the supplemental content during a given period of time.

The method for generating, updating and reassociating financial term objects 400 continues with the publisher storing the financial term object (step 406). In some implementations, the publisher uses the graphical user 108 interface 118 to store the financial term object in the content system manager's financial term object library 120. Once stored, the financial term object is available for association with partners 106.

Then, the publisher associates a financial term object to one or more partners (step 408). In some implementations, the publisher uses the graphical user interface 118 to associate the financial term object with partners. For example, the publisher may associate the financial term object corresponding to a revenue share agreement to all the partners the publisher entered into the revenue share agreement with. In other instances, the publisher assigns the financial term to multiple unrelated partners with which the publisher has entered separate revenue sharing agreements having similar terms. Alternatively, the publisher may assign the same financial term object to multiple content objects or multiple content distribution campaigns independent of the partner involved. In still other implementations, the publisher may assign the same financial term object to various geographies.

Next the publisher updates the financial term object (step 410). In some implementations, the publisher uses the graphical user interface 118 to update the financial term object. In some implementations this step may occur any time after the financial term object has been created. For example, the publisher may have entered into an agreement with partners specializing in sporting content, and agreed to give 20% of generated revenue to the partner. After a period of time, the publisher 104 and partner 106 may agree to change the agreement to provide the partner with 30% of the revenue. In this example, the publisher may update and save the financial term object via the graphical user interface 118.

The method for generating, updating and reassociating financial term objects 400 continues with the financial term object being re-associated with all parties to which it was previously associated. In some implementations, the dissemination would occur automatically after the publisher updates the financial term object. In other implementations, the publisher may wish to only update the financial term object for a subset of partners. In some implementations, this step allows the publisher to quickly update a plurality of financial terms with a plurality of partners by updating a single financial term object. In some implementations, the financial term object may be reapplied to previous revenue allocations. For example, a publisher could update a financial term object during a billing period and have the updated financial term object retroactively apply to revenue calculations from the beginning of the billing period.

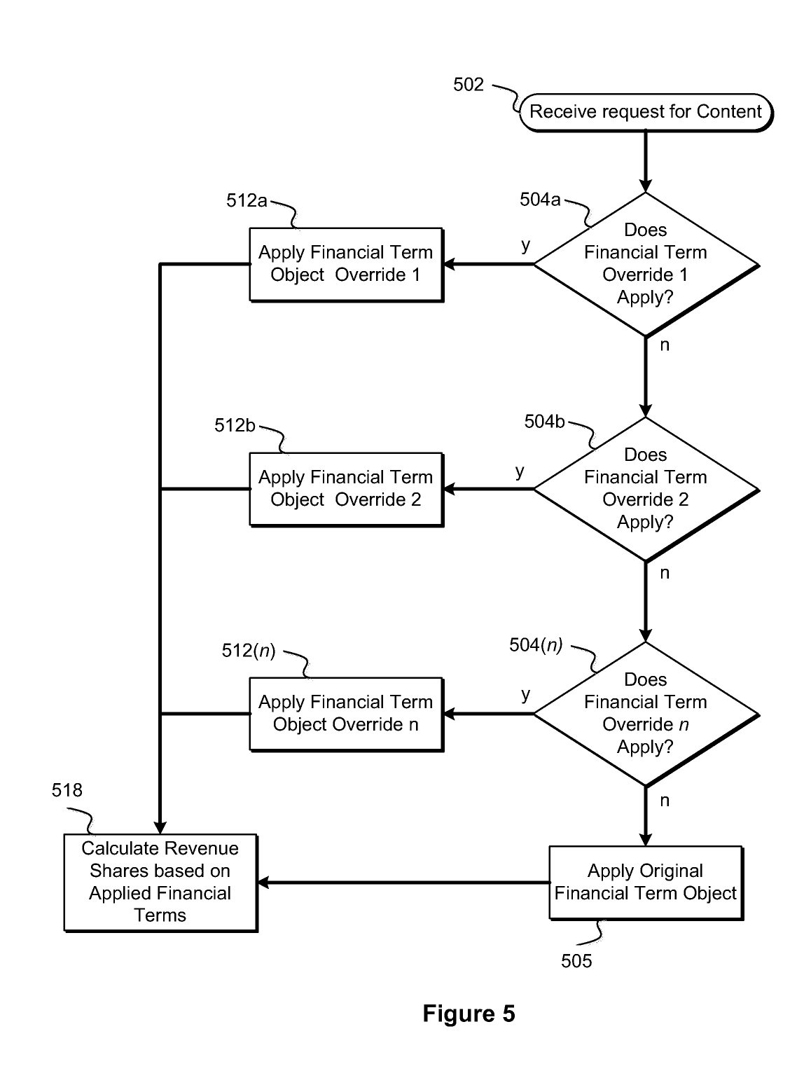

FIG. 5 is a flow chart illustrating a method for applying financial term override objects 500. A financial term override object is a data object which provides exceptions to default financial term objects intended to cover scenarios in which publishers offer different revenue share terms to their publishers under limited circumstances or for limited time durations. Allowing for financial term override objects permits publishers to increase their reuse of less complex, default financial term objects by incorporating more complex content parameter-dependent revenue share rules into financial term override objects. In some embodiments, these parameters may include the partner displaying the content, the inventory unit (the size and specific location where supplemental content appears), the supplemental content provider, the campaign, the line item (a commitment for a supplemental content provider to purchase a specific number of views, clicks or impressions at a specified price), the priority level of the content, content type, contend ID, or geographical location of the user 108 viewing the content. In some implementations, the financial term override object allows the publisher and partners to create specific exceptions to the previously agreed upon revenue share agreement. For example, a partner and publisher may wish to implement different terms for their revenue share agreement for a specific amount of time corresponding to a specific event such as a national sporting event. Rather than create an entirely new financial term object to handle this relationship, the publisher may institute a financial term override object to cover the arrangements made for the specific event. The partner and publisher may define the financial term override object to only apply to the revenue share calculations for the week prior to the sporting event. In other examples, the publisher and partner may wish to have this financial term override repeat yearly to correspond to a yearly sporting event.

This method 500 begins when a request is made to calculate revenue shares (step 502). Then a decision is made if a financial term override object applies with respect a particular impression or set of impressions associated with one or more supplemental content items (steps 504a-504(n). If a financial term override object is determined to apply, it is used to determine an appropriate revenue share (steps 512a-512n). If no financial term override objects are found to be applicable, the default financial term object is applied (step 505). The revenue shares are calculated based on the applied financial terms (step 518). In certain embodiments, a financial term override object can be placed on any campaign parameter that is associated with content being provided to the partner.

As set forth above the method for applying financial term override objects 500 begins when a request is made to calculate the revenue shares for the parties involved in the display of content to a user 108 (step 502). In some embodiments, the revenue calculator 116 receives a request to calculate a plurality of revenue shares. The revenue calculator 116 may then access the financial term object library to retrieve a default financial terms object and the plurality of financial term override objects associated with a revenue share agreement.

Next the revenue calculator 116 determines if a financial term override object applies (step 504a). In some embodiments, at each decision step 504a-504(n), the revenue calculator 116 determines if the financial term override object applies. If the financial term override object does not apply the method continues to process the next financial term override object. If, however, the current content transaction meets the criteria of the particular, then the decision tree is exited and the method proceeds to apply the financial term override object (step 512). In some implementations, the financial term override objects may be arranged in a hierarchical manner such that one financial term override object may override another. In such an implementation, the financial term override objects are associated in order of importance. For example, a revenue share agreement may state that revenue is to have an 80/20 split for a static image content type and a 70/30 split when the supplemental content is generated by a specific supplemental content provider. If, for example, the supplemental content provider parameter was agreed to have a higher priority than the content type parameter in the revenue share agreement, then when the partner displays static image content generated by the specific supplemental content provider the 70/30 split would be used to determine the revenue shares.

As set forth above, the method for applying financial term override objects 500 continues with the financial term override object corresponding to the matching 504 step (if any) being applied to the current content transaction (step 512-512(n)). In some implementations, after the revenue calculator 116 has determined a financial term override object's application criteria have been met, it overrides the default financial term object with the financial term override object. In some implementations, the financial term override object application criteria may contain a plurality of requirements. In fact, in some implementations, the criteria to apply a financial term override object can be any Boolean combination of supplemental content parameters. For example, one illustrative criteria set may require that supplemental content parameter criteria relating to priority level, supplemental content provider, and the user's geographical location must all be met for the financial term override object to be applied. In other examples, only one supplemental content parameter may have to be true for the financial term override object to be applied.

In some embodiments, if no financial term override objects are determined to match the current circumstances of the content display, then the original default financial term object is applied without alteration by a financial term override object.

Finally, the revenue shares are calculated (step 518). In some implementations, the revenue calculator 116 may request information about the user's interaction with the content from the content distribution manager 122. Then, the revenue calculator 116 may calculate the revenue shares due each party based on the financial term objects (default or override) the revenue calculator 116 previously determined meet the content criteria requirements. In some implementations, the revenue calculator 116 may then report this data back to the partner and publisher via the graphical user interface 118.

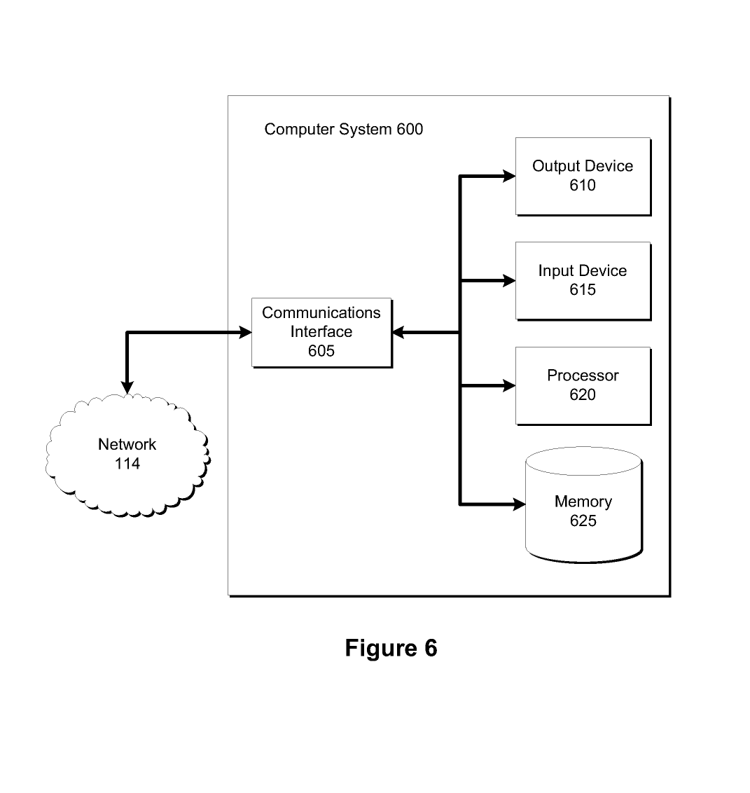

FIG. 6 shows the general architecture of an illustrative computer system 600 that may be employed to implement any of the computer systems discussed herein (including the system 100) in accordance with some embodiments. The computer system 600 of FIG. 6 comprises one or more processors 620 communicatively coupled to memory 625, one or more communications interfaces 605, and one or more output devices 610 (e.g., one or more display units) and one or more input devices 615.

In the computer system 600 of FIG. 6, the memory 625 may comprise any computer-readable storage media, and may store computer instructions such as processor-executable instructions for implementing the various functionalities described herein for respective systems, as well as any data relating thereto, generated thereby, or received via the communications interface(s) or input device(s) (if present). The processor(s) 620 shown may be used to execute instructions stored in the memory 625 and, in so doing, also may read from or write to the memory various information processed and or generated pursuant to execution of the instructions.

The processor 620 of the computer system 600 also may be communicatively coupled to or control the communications interface(s) 605 to transmit or receive various information pursuant to execution of instructions. For example, the communications interface(s) 605 may be coupled to a wired or wireless network, bus, or other communication means and may therefore allow the computer system 600 to transmit information to and/or receive information from other devices (e.g., other computer systems). While not shown explicitly in the system of FIG. 1, one or more communications interfaces facilitate information flow between the components of the system 100. In some implementations, the communications interface(s) may be configured (e.g., via various hardware components or software components) to provide a website as an access portal to at least some aspects of the computer system 600. Examples of communications interfaces 605 include user interfaces (e.g., web pages) having content.

The output devices 610 of the computer system 600 may be provided, for example, to allow various information to be viewed or otherwise perceived in connection with execution of the instructions. The input device(s) 615 may be provided, for example, to allow a user 108 to make manual adjustments, make selections, enter data or various other information, or interact in any of a variety of manners with the processor during execution of the instructions. Additional information relating to a general computer system architecture that may be employed for various systems discussed herein is provided at the conclusion of this disclosure.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. The program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor receives instructions and data from a read only memory or a random access memory or both. The essential elements of a computer are a processor for performing actions in accordance with instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube), plasma, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as system 600 or system 100 can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of the systems and methods described herein. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

For situations in which the systems discussed here collect personal information about users, or may make use of personal information, the users may be provided with an opportunity to control whether programs or features that may collect personal information (e.g., information about a user's social network, social actions or activities, a user's preferences, or a user's current location), or to control whether and/or how to receive content from the content server that may be more relevant to the user. In addition, certain data may be anonymized in one or more ways before it is stored or used, so that personally identifiable information is removed when generating monetizable parameters (e.g., monetizable demographic parameters). For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server.

In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Having now described some illustrative implementations and embodiments, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one embodiment are not intended to be excluded from a similar role in other implementations or embodiments.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate embodiments consisting of the items listed thereafter exclusively. In one embodiment, the systems and methods described herein consist of one, each combination of more than one, or all of the described elements, acts, or components.

Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements to single or plural configurations. References to any act or element being based on any information, act or element may include embodiments where the act or element is based at least in part on any information, act, or element.

Any implementation disclosed herein may be combined with any other implementation or embodiment, and references to “an implementation,” “some implementation,” “an alternate implementation,” “various implementation,” “one implementation” or the like are not necessarily mutually exclusive and are intended to indicate that a particular feature, structure, or characteristic described in connection with the embodiment may be included in at least one implementation or embodiment. Such terms as used herein are not necessarily all referring to the same embodiment. Any embodiment may be combined with any other embodiment, inclusively or exclusively, in any manner consistent with the aspects and embodiments disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing embodiments are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A computer system for the creation and management of financial term objects, the system comprising:
at least one processing circuit configured to:
generate, based on a publisher's input, a financial term object, wherein the financial term object comprises a set of rules that govern how revenue is divided between a partner and a publisher when a supplemental content article is displayed to a user in response to the user accessing an online property of the partner;
store the financial term object in a database;
associate the financial term object with a publisher and a first partner;
associate the financial term object with the publisher and a second partner;
associate a second financial term object with the publisher and a third partner;
calculate at least one revenue share owed to each of the first, second, and third the partners based on one of the financial term object or and the second financial term object.

2. The system of claim 1, wherein in response to receiving an update to the financial term object, the processing circuit is configured to apply the update to the financial term object to all future revenue allocations between the publisher and the first and second partners.

3. The system of claim 1, wherein in response to receiving an update to the financial term object, the processing circuit is configured to retroactively apply the update to the financial term object to at least one previous revenue allocation between the publisher and the first and second partners.

4. The system of claim 1, wherein the set of rules comprises a first revenue share associated with a first geographic location.

5. The system of claim 4, wherein the set of rules comprises a second revenue share associated with a second geographic location.

6. The system of claim 1, wherein the set of rules comprises a revenue share associated with the total number of previous impressions associated with the supplemental content.

7. The system of claim 1, wherein the set of rules comprises a first revenue share associated with a first content size.

8. The system of claim 7, wherein the set of rules comprises a second revenue share associated with a second content size.

9. The system of claim 1, wherein the set of rules comprises a first revenue share associated with a first content type.

10. The system of claim 9, wherein the set of rules comprises a second revenue share associated with a second content type.

11. The system of claim 1, where in the supplemental content article comprises an online advertisement.

12. The system of claim 1, wherein the at least one processor circuit is configured to output a user interface for use in generating the financial term object.

13. A method for the creation and management of financial term objects, the method comprising:
generating, by at least one processing circuit and based on a publisher's input, a financial term object, wherein the financial term object comprises a set of rules that govern how revenue is divided between a partner and a publisher when a supplemental content article is displayed to a user in response to the user accessing an online property of the partner;
storing, by the at least one processing circuit, the financial term object in a database;
associating, by the at least one processing circuit, the financial term object with a publisher and a first partner;
associating, by the at least one processing circuit, the financial term object with the publisher and a second partner;
associating, by at the least one processing circuit, a second financial term object with the publisher and a third partner;
calculating, by the at least one processing circuit, at least one revenue share owed to each of the first, second, and third partners based on the financial term object and the second financial term object.

14. The method of claim 13, wherein in response to receiving an update to the financial term object, applying, by the at least one processing circuit, the update to the financial term object to all future revenue allocations between the publisher and the first and second partners.

15. The method of claim 13, wherein in response to receiving an update to the financial term object, retroactively applying, by the at least one processing circuit, the update to the financial term object to at least one previous revenue allocation between the publisher and the first and second partners.

16. The method of claim 13, wherein the set of rules comprise a first revenue share associated a first geographic location and a second revenue share associated with a second geographic location.

17. The method of claim 13, wherein the set of rules comprises a revenue share associated with the total number of previous impressions associated with the supplemental content.

18. The method of claim 13, wherein the set of rules comprises a first revenue share associated with a first content size and a second revenue share associated with a second content size.

19. The method of claim 13, wherein the set of rules comprises a first revenue share associated with a first content type and a second revenue share associated with a second content type.

20. The method of claim 13, where in the supplemental content article comprises an online advertisement.

21. The method of claim 13, comprising outputting, by the at least one processor circuit, a user interface for use in generating the financial term object.

22. A computer readable medium having instructions stored thereon, which when executed, by at least one processing circuit, causes the at least one processing circuit to:
generate, based on a publisher's input, a financial term object, wherein the financial term object comprises a set of rules that govern how revenue is divided between a partner and a publisher when a supplemental content article is displayed to a user in response to the user accessing an online property of the partner;
store the financial term object in a database;
associate the financial term object with a publisher and a first partner;
associate the financial term object with the publisher and a second partner;
associate a second financial term object with the publisher and a third partner;
calculating the at least one revenue share owed to each of the first, second, and third partners based on the at least one financial term object and the second financial term object.

23. The computer readable medium of claim 22, wherein the set of rules comprise a first revenue share associated a first geographic location and a second revenue share associated with a second geographic location.

24. The computer readable medium of claim 22, wherein the set of rules comprises a first revenue share associated with a first content type and a second revenue share associated with a second content type.
